(19) United States
(12) Patent Application Publication
(10) Pub. No.: US 2026/0265512 A1
(43) Pub. Date: Sep. 10, 2026

(54) OLEFIN-BASED COMPOSITION, RESIN MOLDED PRODUCT, AND METHOD FOR PRODUCING OLEFIN-BASED COMPOSITION

(71) Applicant: TOYODA GOSEI CO., LTD., Kiyosu-shi (JP)

(72) Inventors: Hitoshi UCHIDA, Aichi (JP); Yasuaki TANAKA, Aichi (JP); Yoshiki NAKAMURA, Aichi (JP)

(21) Appl. No.: 19/550,422

(22) Filed: Feb. 26, 2026

(30) Foreign Application Priority Data
Mar. 10, 2025 (JP) 2025-037087

(51) Int. Cl. C08L 23/12; C08J 3/24

(52) U.S. Cl. CPC C08L 23/12; C08J 3/24; C08J 2323/12; C08J 2423/06; C08J 2423/08; C08J 2423/12; C08L 2205/025; C08L 2205/035; C08L 2207/20; C08L 2312/00

(57) ABSTRACT

In order to recycle used polypropylene into an olefin-based composition with a reduced odor, which can be generally reused in a wide range of applications in which polypropylene is applied, an olefin-based composition containing: used polypropylene; and crosslinked ethylene-α-olefin copolymer rubber in a mass smaller than a mass of the used polypropylene is provided. The olefin-based composition may further contain crosslinked polyethylene. The olefin-based composition may further contain high-flow polypropylene having higher fluidity than the used polypropylene.

### CROSS-REFERENCE TO RELATED APPLICATION

This application is based on and claims priority under 35 USC 119 from Japanese Patent Application No. 2025-037087 filed on Mar. 10, 2025.

### TECHNICAL FIELD

The present disclosure relates to an olefin-based composition obtained by recycling used polypropylene.

### BACKGROUND ART

Used polypropylene recovered from post-consumers is regenerated and recycled. Since the used polypropylene has problems that the used polypropylene often emits an odor due to an odor component contained therein or often has poor fluidity, it is required to alleviate these problems.

Patent Literature 1 describes that a polypropylene resin composition containing polypropylene recovered from the market, polypropylene recovered in the process, and virgin polypropylene, in which the content of the virgin polypropylene is 15% by mass or more based on 100% by mass of the total mass of the polypropylene resin composition, makes it possible to obtain a molded body having a relatively reduced odor while reusing polypropylene.

However, the reduction in the odor is not sufficient, and further reduction in the odor is required for use in, for example, a molded product for an automobile interior.

The following Patent Literatures 2 to 5 do not relate to recycling of used polypropylene, but are cited as examples of extrusion processing of polypropylene.

Patent Literature 2 describes that an extruded multilayer structure including a first outer layer including a film layer of a polypropylene composition oriented in a machine direction, a second outer layer including a film layer of a non-oriented polypropylene composition, and a core layer between the two outer layers, the core layer including a film layer of branched polypropylene, and not including any layer of an adhesive that is not a polypropylene composition, is recyclable and has an improved balance of mechanical properties.

However, neither the odor nor the fluidity at the time of recycling the extruded multilayer structure is considered.

Patent Literature 3 describes a method of adjusting viscosity by kneading polypropylene and a peroxide with a kneading extruder, reacting the polypropylene with the peroxide at a high temperature, and cutting the main chains of the polypropylene molecules to reduce the molecular weight.

However, since the polypropylene is not used polypropylene, odor is not regarded as a problem. In addition, the recycled material may contain random polypropylene or polyethylene, and the fluidity may be deteriorated due to crosslinking.

Patent Literature 4 describes a method for producing an adhesive by supplying polypropylene to a first extrusion section of an extruder to perform thermomechanical decomposition in the presence of a peroxide by shear stress, and then blending a tackifier resin with the decomposed polypropylene in a second extrusion section.

However, since the polypropylene is not used polypropylene, odor is not regarded as a problem.

Patent Literature 5 describes a method for producing a thermoplastic elastomer excellent in appearance of a molded product and processability during molding by feeding a rubber component (ethylene-α-olefin-based copolymer rubber), a resin component (olefin-based resin), and a part of a crosslinking agent (organic peroxide) into a twin-screw extrusion kneader, crosslinking the rubber component at the same time as kneading, subsequently feeding the remaining crosslinking agent after a predetermined time, and then performing kneading and crosslinking.

However, since the olefin-based resin is not a used resin, odor is not regarded as a problem. In addition, in Example 1 and Comparative Example 1 of Patent Literature 5, 80.6% by weight of the rubber component and 19.4% by weight of the resin component are kneaded to produce an elastomer mainly composed of rubber, which is generally less likely to be used for applications to which polypropylene is applied.
Patent Literature 1: JP7461556B
Patent Literature 2: JP7315717B
Patent Literature 3: JP5560450B
Patent Literature 4: JP6165915B
Patent Literature 5: JP2002-194095A

### SUMMARY OF INVENTION

An object of the present disclosure is to recycle used polypropylene into an olefin-based composition with a reduced odor, which can be generally reused in a wide range of applications in which polypropylene is applied.

An odor component contained in the used polypropylene is assumed to be a low-molecular-weight substance having a molecular weight of less than 1,000 such as aldehyde (formaldehyde, acetaldehyde), amine (aliphatic amine, diethylamine, hydroxylamine, aromatic amine, and the like), and thiol, and when present in a composition, the odor component volatilizes from the composition at Tg (about 0° C.) or higher of the polypropylene. The present inventors have come up with the idea of reducing the odor by retaining such a low-molecular-weight substance in a crosslinked body, and have conducted studies to achieve the present disclosure.
[1] An olefin-based composition containing used polypropylene and crosslinked ethylene-α-olefin copolymer rubber in a mass smaller than a mass of the used polypropylene.
[2] The olefin-based composition according to [1], in which a mass ratio of the used polypropylene to a total polymer in the olefin-based composition is 20 to 60% by mass, and a mass ratio of the ethylene-α-olefin copolymer rubber to the total polymer in the olefin-based composition is 5 to 25% by mass. Here, the “polymer” is a concept including a resin, rubber, and an elastomer.
[3] The olefin-based composition according to [1] or [2], in which crosslinked polyethylene is not contained or is further contained, and a total mass ratio of the ethylene-α-olefin copolymer rubber and the polyethylene to the total polymer in the olefin-based composition is 10 to 30% by mass.
[4] The olefin-based composition according to any of [1] to [3], further containing: high-flow polypropylene having a higher fluidity than a fluidity of the used polypropylene, in which a mass ratio of the high-flow polypropylene to a total resin in the olefin-based composition is 15 to 60% by mass.
[5] The olefin-based composition according to any of [1] to [4], having an MFR (230° C., 21.2 N) of 15 g/10 min or more.
[6] The olefin-based composition according to any of [1] to [5], having a Charpy impact strength (23° C.) of 7 kJ/m² or more.
[7] The olefin-based composition according to any of [1] to [6], having a tensile elastic modulus (23° C.) of 1.8 GPa or more.
[8] The olefin-based composition according to any of [1] to [7], in which an odor intensity by a sensory test is 3 points or less on a scale of 1 to 5 points.
[9] A resin molded product molded from the olefin-based composition according to any of [1] to [8].
[10] A method for producing an olefin-based composition, including: a first mixing a raw material containing used polypropylene, uncrosslinked ethylene-α-olefin copolymer rubber in a mass smaller than a mass of the used polypropylene, and a peroxide to crosslink the ethylene-α-olefin copolymer rubber with the peroxide.
[11] The method for producing an olefin-based composition according to [10], in which in the first mixing, the raw material contains no polyethylene or further contains polyethylene, and when the raw material contains polyethylene, the polyethylene is crosslinked with the peroxide.
[12] The method for producing an olefin-based composition according to [11], in which a mass ratio of the peroxide to a total of the ethylene-α-olefin copolymer rubber and the polyethylene is 1 to 11% by mass.
[13] The method for producing an olefin-based composition according to any of to [12], in which in the first mixing, the raw material further contains high-flow polypropylene having a higher fluidity than a fluidity of the used polypropylene.
[14] The method for producing an olefin-based composition according to any of to [12], further including: a second mixing a mixture obtained in the first mixing with high-flow polypropylene having a higher fluidity than a fluidity of the used polypropylene.
[15] The method for producing an olefin-based composition according to any of to [14], in which the mixing is performed by a kneading extruder.

### <Action of Olefin-Based Composition>

As described above, the odor component contained in the used polypropylene is assumed to be a low-molecular-weight substance having a molecular weight of less than 1,000, and when present in the composition, the odor component volatilizes from the composition at Tg or higher of the polypropylene. FIG. 1A illustrates the vicinity of a surface of a molded product obtained by remelting and molding used polypropylene. An odor component derived from the used polypropylene migrates in the molded product, reaches the surface, and volatilizes, thereby producing an odor.

FIG. 1B illustrates the vicinity of a surface of an olefin-based composition according to Comparative Examples described later or a molded product thereof, in which uncrosslinked ethylene-α-olefin copolymer rubber is dispersed in a matrix of used polypropylene. Since a substantial portion of an odor component derived from the used polypropylene passes through the uncrosslinked rubber, reaches the surface, and volatilizes, the odor becomes a problem.

On the other hand, FIG. 1C illustrates the vicinity of a surface of an olefin-based composition according to the present disclosure or a molded product thereof, in which crosslinked ethylene-α-olefin copolymer rubber is dispersed in a matrix of used polypropylene. Since most of an odor component derived from the used polypropylene is retained by the crosslinked rubber during migration, and only a part of the odor component reaches the surface, it is considered that the odor is reduced. The fact that the crosslinked rubber retains the low-molecular-weight substances can also be understood based on the fact that, for example, the crosslinked rubber retains a low-molecular-weight process oil or the like to obtain flexibility.

In addition, the olefin-based composition according to the present disclosure is a composition mainly composed of polypropylene (used polypropylene is more than rubber), and thus can be generally reused in a wide range of applications in which polypropylene is applied.

The olefin-based composition may further contain crosslinked polyethylene. Improvement in weather resistance and the like of the composition can be expected. The polyethylene may be virgin polyethylene or used polyethylene. In addition, it is considered that the crosslinked polyethylene retains the odor component derived from the used polypropylene and also retains the odor component of the used polyethylene itself.

Hereinafter, the crosslinked ethylene-α-olefin copolymer rubber or the crosslinked polyethylene may be simply referred to as a “crosslinked body”.

The olefin-based composition may further contain high-flow polypropylene having higher fluidity than that of the used polypropylene. It is preferable when it is desired to further increase the fluidity of the olefin-based composition.

### <Action of Method for Producing Olefin-Based Composition>

As a first mixing, the used polypropylene and the uncrosslinked ethylene-α-olefin copolymer rubber are mixed, and at the same time, (a) the ethylene-α-olefin copolymer rubber is crosslinked with the peroxide. (b) When the raw material further contains polyethylene, the polyethylene is also crosslinked with the peroxide. (c) The used polypropylene is decomposed by the peroxide, and the molecular weight is decreased. (d) When the raw material further contains high-flow polypropylene, the high-flow polypropylene is also decomposed by the peroxide, and the molecular weight is decreased.

The used polypropylene generally has a higher molecular weight and a lower MFR than those of the virgin polypropylene, but when the used polypropylene is decomposed and the molecular weight is decreased in (c), the MFR increases and the fluidity of the olefin-based composition increases. In addition, the high-flow polypropylene, which is virgin polypropylene, also has its MFR further increased in (d). A decomposition residue formed by decomposition of the peroxide itself is a causative substance of the odor, but is retained in a crosslinked body crosslinked in (a) and (b) and is difficult to volatilize to the outside of the composition, and thus it is less likely to increase the odor.

When the second mixing the high-flow polypropylene with the mixture obtained in the first mixing is performed, the peroxide in the first mixing is not consumed in the decomposition of (d) but is consumed by preferentially acting on the crosslinking of (a) and (b), which is advantageous in reducing the odor. The peroxide thus consumed rarely acts on the decomposition of the high-flow polypropylene mixed in the second mixing. On the other hand, when the high-flow polypropylene is decomposed in (d) as described above, the fluidity of the composition increases.

Therefore, it is possible to select any of the following in accordance with a degree of the fluidity as a sub object while reducing the odor as a main object.
The high-flow polypropylene is also mixed in the first mixing (advantageous in fluidity).
The high-flow polypropylene is mixed in the second mixing (advantageous in reduction of odor).
The high-flow polypropylene and the peroxide added to decompose the high-flow polypropylene are mixed in the second mixing (emphasis on both odor reduction and fluidity).

According to the present disclosure, used polypropylene can be recycled into an olefin-based composition with a reduced odor, which can be generally reused in a wide range of applications in which polypropylene is applied.

### BRIEF DESCRIPTION OF DRAWINGS

FIG. 1A is a cross-sectional view schematically illustrating the vicinity of a surface of a molded product of used polypropylene.

FIG. 1B is a cross-sectional view schematically illustrating the vicinity of a surface of a molded product of an olefin-based composition according to Comparative Examples.

FIG. 1C is a cross-sectional view schematically illustrating the vicinity of a surface of a molded product of an olefin-based composition according to the present disclosure.

FIG. 2 is a side view illustrating a method for producing an olefin-based composition according to Examples.

FIG. 3 is a graph plotting results of an odor test of Examples 1 to 9 in association with (rubber+PE)/total polymer.

### DESCRIPTION OF EMBODIMENTS

### <1> Used Polypropylene

Examples of the origin (usage) of used polypropylene include, but are not particularly limited to, resin parts of automobiles, containers, home appliances, and the like recovered from post-consumers, and a resin (including shredder dust) recovered in a process. The use time, the use status, and the like of the used polypropylene are not particularly limited.

The used polypropylene is not particularly limited, and may be a homopolymer or a copolymer (random polypropylene or block polypropylene).

A mass ratio of the used polypropylene to a total polymer in the olefin-based composition is preferably from 20 to 60% by mass, and more preferably from 25 to 50% by mass. When the mass ratio is 20% by mass or more, more used polypropylene can be used. When the mass ratio is 60% by mass or less, the odor is likely to decrease.

### <2> Ethylene-α-Olefin Copolymer Rubber

Ethylene-α-olefin copolymer rubber is copolymer rubber of ethylene and an α-olefin.

The α-olefin is not particularly limited, but is preferably an α-olefin having 3 to 20 carbon atoms, and examples thereof include propylene, 1-butene, 1-pentene, 1-hexene, 4-methyl-1-pentene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 9-methyl-1-decene, 11-methyl-1-dodecene, and 12-ethyl-1-tetradecene. The α-olefins may be used alone or in combination with one another.

A mass ratio of the ethylene-α-olefin copolymer rubber to the total polymer in the olefin-based composition is preferably from 5 to 25% by mass, and more preferably from 8 to 18% by mass. When the mass ratio is 5% by mass or less, the odor is likely to be reduced. When the mass ratio is 25% by mass or less, the properties as polypropylene in the composition are likely to be maintained.

### <3> Polyethylene

Examples of the polyethylene include, but are not particularly limited to, low-density polyethylene, high-density polyethylene, and ultra-high-molecular-weight polyethylene. Polyethylene having a molecular weight of 50,000 to 500,000 is preferable in terms of a good balance between impact resistance and fluidity.

The polyethylene may be virgin polyethylene or used polyethylene as described above. When the polyethylene is used polyethylene, since an odor component contained in the used polyethylene is also retained in the crosslinked body and hardly volatilized to the outside of the composition, the odor derived from the used polyethylene is also reduced.

A mass ratio of a total of the ethylene-α-olefin copolymer rubber and polyethylene to the total polymer in the olefin-based composition is preferably from 10 to 30% by mass, and more preferably from 13 to 28% by mass. When the mass ratio is 10% by mass or more, the odor is likely to decrease. When the mass ratio is 30% by mass or less, the properties as polypropylene in the composition are likely to be maintained.

A mass ratio of polyethylene to the total polymer in the olefin-based composition is preferably 20% by mass or less, and more preferably 14% by mass or less. When the mass ratio is 20% by mass or less, the properties as polypropylene in the composition are likely to be maintained.

### <4> Crosslinking Agent

Examples of a crosslinking agent include, but are not particularly limited to, peroxides, sulfur, quinoid crosslinking agents, resin crosslinking agents, azo polymerization initiators, and hydrosilicones.

As described above, the peroxide is preferable in that it has an action of decomposing polypropylene and increasing fluidity. A decomposition residue formed by decomposition of the peroxide is a causative substance of the odor, but is retained in a crosslinked body in the present composition and is less likely to volatilize to the outside of the composition, and thus the odor is less likely to increase. Examples of the peroxide include, but are not particularly limited to, organic peroxides such as t-butyl peroxide, dicumyl peroxide, and 2,5-dimethyl-2,5-di(t-butylperoxy) hexane, and azo polymerization initiators such as azobisisobutyronitrile.

A mass ratio of the peroxide to a total of the ethylene-α-olefin copolymer rubber and the polyethylene is not particularly limited, but is preferably 1 to 11% by mass, more preferably 1.5 to 8% by mass, and most preferably 1.5% to 5.6% by mass. When the mass ratio is 1% by mass or more, a crosslinking reaction between the ethylene-α-olefin copolymer rubber and the polyethylene is more sufficiently performed. When the mass ratio is 11% by mass or less, the peroxide is less likely to be excessive, and thus the odor due to the decomposition residue of the peroxide itself is less likely to increase.

### <5> High-flow Polypropylene

High-flow polypropylene may have higher fluidity than the used polypropylene, and the MFR (230° C., 21.2 N) is preferably 30 g/10 min or more, and more preferably 50 g/10 min or more. This is because the fluidity of the composition is likely to increase.

A mass ratio of the high-flow polypropylene to a total resin in the olefin-based composition is preferably 15 to 60% by mass, and more preferably 24 to 58% by mass. When the mass ratio is 15% by mass or more, the fluidity is likely to increase. When the mass ratio is 60% by mass or less, the odor is likely to decrease.

### <6> Other Additives

In addition to the above materials, other polymers, talc, whiskers, calcium carbonate, kaolin clay, mica, antioxidants, ultraviolet absorbers, light stabilizers, flame retardants, colorants, and the like may be added to the raw material.

### <7> MFR

The MFR (230° C., 21.2 N) of the olefin-based composition is preferably 15 g/10 min or more, and more preferably 20 g/10 min or more. This is because molding is easy when the fluidity is high.

### <8> Charpy Impact Strength

A Charpy impact strength (23° C.) of the olefin-based composition is preferably 7 kJ/m² or more, and more preferably 12 kJ/m² or more. This is because the molded product is less likely to be damaged.

### <9> Tensile Elastic Modulus

A tensile elastic modulus (23° C.) of the olefin-based composition is preferably 1.8 GPa or more, and more preferably 2 GPa or more. This is because the molded product is less likely to be damaged.

### <10> Odor Intensity

An odor intensity by a sensory test is preferably 3 points or less, and more preferably 2 points or less, on a scale of 1 to 5 points.

### <11> Resin Molded Product

Examples of a resin molded product molded from the olefin-based composition according to the present disclosure include, but are not limited to, an interior or exterior part (including exterior panel) for an automobile, an intake or exhaust component, an interior or exterior part (including exterior panel) for a railway vehicle and a building, and a housing and a part of an electrical appliance. Examples of the interior or exterior part for an automobile include a bonnet hood, a fender, a bumper, a door, a trunk lid, a roof, a radiator grill, a wheel cap, an instrument panel, a pillar garnish, a glove box, a console, a scuff plate, door trim, an air duct, and an airbag cover.

### <12> Method for Mixing Raw Materials

Examples of a method for mixing raw materials include, but are not limited to, kneading performed by a continuous kneader, a batch kneader, or the like.

Examples of the continuous kneader include, but are not limited to, a kneading extruder (single-screw, twin-screw, or the like), and a continuous kneader.

Examples of the batch kneader include, but are not limited to, a closed-type kneader such as a Banbury mixer, a kneader, and an internal mixer, and an open-type kneader such as an open roll machine.

From the viewpoint of efficiency, kneading with a kneading extruder is preferred. The kneading extruder may be a single-screw kneading extruder or a twin-screw kneading extruder, and the twin-screw kneading extruder is preferable in terms of high conveyance speed.

The first mixing and the second mixing may be performed by one kneading extruder as in Examples described later, or may be performed by separate kneading extruders (two kneading extruders in series).

### EXAMPLES

Examples of the present disclosure will be described. Hereinafter, polypropylene may be referred to as “PP”, polyethylene may be referred to as “PE”, and ethylene-α-olefin copolymer rubber may be simply referred to as “rubber”. Materials, conditions, structures, shapes, and dimensions of the examples are merely examples, and can be appropriately modified without departing from the spirit of the invention.

Olefin-based compositions of Examples 1 to 9 and Comparative Examples 1 and 2 were prepared by mixing raw materials in which materials shown in the following Table 1 were blended.

TABLE 1

| | | | Property | Example | Example | Example | Example | Example | Example |
|---|---|---|---|---|---|---|---|---|---|
| | Type | Grade | value | 1 | 2 | 3 | 4 | 5 | 6 |
| Raw | Used PP | Used PP1 | MFR 4 | 25 | 30 | | 16 | | 40 |
| materials | | Used PP2 | MFR 23 | 5 | | 20 | 20 | 30 | |
| | | Used PP3 | MFR 12 | | 10 | | | | |
| | PE | Used PE | MFR 3 | 5 | | | 10 | | 5 |
| | | Virgin PE | MFR 5 | | 7.5 | | | 10 | |
| | High- | High- | MFR 60 | | 20 | 20 | 20 | | 20 |
| | flow PP | flow PP1 | | | | | | | |
| | | High- | MFR 50 | 30 | | 20 | | 30 | 4.7 |
| | | flow PP2 | | | | | | | |
| | Rubber | Ethylene-α- | | 8.5 | 12 | 9.7 | 8 | 6 | 15 |
| | | olefin | | | | | | | |
| | | copolymer | | | | | | | |
| | | rubber | | | | | | | |
| | Peroxide | Perhexa 258 | | 0.5 | 0.5 | 0.3 | 0.8 | 0.5 | 0.3 |
| | Talc | Talc 70 wt % | (PP | 26 (8) | | 30 (9) | | 10 (3) | |
| | | charged PP | content) | | | | | | |
| | | masterbatch | | | | | | | |
| | | Powder talc | | | 20 | | 25.2 | 13.5 | 15 |
| | Total (wt %) | | | 100 | 100 | 100 | 100 | 100 | 100 |
| | Used PPA/total | | | 37 | 50 | 25 | 49 | 38 | 47 |
| | polymer (wt %) | | | | | | | | |
| | Rubber/total | | | 10 | 15 | 12 | 11 | 8 | 16 |
| | polymer (wt %) | | | | | | | | |
| | PE/total | | | 6 | 9 | 0 | 14 | 13 | 6 |
| | polymer (wt %) | | | | | | | | |
| | (Rubber + PE)/total | | | 17 | 25 | 12 | 24 | 20 | 24 |
| | polymer (wt %) | | | | | | | | |
| | High-flow PP/total | | | 41 | 30 | 58 | 30 | 41 | 35 |
| | resin (wt %) | | | | | | | | |
| | Peroxide/(rubber + | | | 3.7 | 2.6 | 3.1 | 4.4 | 3.1 | 1.5 |
| | PE) (wt %) | | | | | | | | |
| Mixing | Kneading | Twin-screw/ | | Twin- | Twin- | Single- | Single- | Twin- | Twin- |
| | | single-screw | | screw | screw | screw | screw | screw | screw |
| | | kneading extruder | | | | | | | |
| Compo- | Evaluation items | | Target | | | | | | |
| sition | Odor | Odor | 3↓ | 1.5 | 1.2 | 2 | 1 | 1.5 | 1.5 |
| | evaluation | intensity | | | | | | | |
| | | (score) | | | | | | | |
| | | Degree | 1↓ | 0 | −0.5 | 1 | −0.5 | 0 | 0 |
| | | of odor | | | | | | | |
| | | unpleasantness | | | | | | | |
| | | (score) | | | | | | | |
| | Fluidity | MFR | 15↑ | 25 | 20 | 30 | 23 | 40 | 25 |
| | | (g/10 min) | | | | | | | |
| | Impact | Charpy | 7↑ | 18 | 20 | 17 | 12 | 12 | 20 |
| | property | impact value | | | | | | | |
| | | (kJ/m2) | | | | | | | |
| | Stiffness | Tensile | 1.8↑ | 2.2 | 2.4 | 2.2 | 2.4 | 2 | 2.1 |
| | | elastic | | | | | | | |
| | | modulus | | | | | | | |
| | | (GPa) | | | | | | | |

| | | | | | | | Compar- | Compar- |
|---|---|---|---|---|---|---|---|---|
| | | | Property | Example | Example | Example | ative | ative |
| | Type | Grade | value | 7 | 8 | 9 | Example 1 | Example 2 |
| Raw | Used PP | Used PP1 | MFR 4 | | 7 | 10 | 4 | 5 |
| materials | | Used PP2 | MFR 23 | | 10 | | 30 | 35 |
| | | Used PP3 | MFR 12 | 40 | 10 | 18.9 | | 10 |
| | PE | Used PE | MFR 3 | 3 | | | | 10 |
| | | Virgin PE | MFR 5 | | 10 | | 5 | 10 |
| | High- | High- | MFR 60 | 16 | 15 | 10 | 20 | |
| | flow PP | flow PP1 | | | | | | |
| | | High- | MFR 50 | | 15 | 20 | 10 | |
| | | flow PP2 | | | | | | |
| | Rubber | Ethylene-α- | | 15 | 12 | 10 | 8 | 12 |
| | | olefin | | | | | | |
| | | copolymer | | | | | | |
| | | rubber | | | | | | |
| | Peroxide | Perhexa 258 | | 1 | 0.7 | 1.1 | | |
| | Talc | Talc 70 wt % | (PP | 25 (8) | | 30 (9) | 23 (7) | |
| | | charged PP | content) | | | | | |
| | | masterbatch | | | | | | |
| | | Powder talc | | | 20.3 | | | 18 |
| | Total (wt %) | | | 100 | 100 | 100 | 100 | 100 |
| | Used PPA/total | | | 49 | 34 | 37 | 41 | 61 |
| | polymer (wt %) | | | | | | | |
| | Rubber/total | | | 18 | 15 | 13 | 10 | 15 |
| | polymer (wt %) | | | | | | | |
| | PE/total | | | 4 | 13 | 0 | 6 | 24 |
| | polymer (wt %) | | | | | | | |
| | (Rubber + PE)/total | | | 22 | 28 | 13 | 15 | 39 |
| | polymer (wt %) | | | | | | | |
| | High-flow PP/total | | | 24 | 45 | 44 | 40 | 0 |
| | resin (wt %) | | | | | | | |
| | Peroxide/(rubber + | | | 5.6 | 3.2 | 11 | 0 | 0 |
| | PE) (wt %) | | | | | | | |
| Mixing | Kneading | Twin-screw/ | | Twin- | Twin- | Single- | Twin- | Twin- |
| | | single-screw | | screw | screw | screw | screw | screw |
| | | kneading extruder | | | | | | |
| Compo- | Evaluation items | | Target | | | | | |
| sition | Odor | Odor | 3↓ | 1 | 1.5 | 3 | 4 | 5 |
| | evaluation | intensity | | | | | | |
| | | (score) | | | | | | |
| | | Degree | 1↓ | 0 | −1 | 1 | 2 | 2 |
| | | of odor | | | | | | |
| | | unpleasantness | | | | | | |
| | | (score) | | | | | | |
| | Fluidity | MFR | 15↑ | 35 | 40 | 60 | 30 | 12 |
| | | (g/10 min) | | | | | | |
| | Impact | Charpy | 7↑ | 15 | 12 | 7 | 15 | 20 |
| | property | impact value | | | | | | |
| | | (kJ/m2) | | | | | | |
| | Stiffness | Tensile | 1.8↑ | 2 | 1.9 | 2.5 | 2 | 1.6 |
| | | elastic | | | | | | |
| | | modulus | | | | | | |
| | | (GPa) | | | | | | |

Details of each material in Table 1 are as follows. ·Used PP1: PP mixture mainly composed of random PP manufactured by Toyama Kankyo Seibi Co., Ltd., recovered from used container packaging by a container packaging recycling method, and having an MFR (230° C., 21.2 N) of 4 g/10 minutes. ·Used PP2: block PP manufactured by MATEC Inc. recovered from used PP parts (bumper, interior part, and the like) of an automobile by an automobile recycling method, and having an MFR (230° C., 21.2 N) of 23 g/10 minutes. ·Used PP3: block PP (recycled pellet) manufactured by Green Cycle Systems Co., Ltd., recovered from a used home appliance by a home appliance recycling method or a small home appliance recycling method, and having an MFR (230° C., 21.2 N) of 12 g/10 minutes. In addition, the used PP also includes block PP used for an object (for example, parts box, miscellaneous goods container, or tray used for conveying parts during vehicle manufacturing) other than a home appliance.

·Used PE: PE mixture manufactured by Toyama Kankyo Seibi Co., Ltd., recovered by a container packaging recycling method, recovered by an automobile recycling method, and recovered by a home appliance recycling method, and having an MFR (230° C., 21.2 N) of 3 g/10 minutes. ·Virgin PE: high-density PE (trade name: HJ360) manufactured by Japan Polyethylene Corporation, and having an MFR (230° C., 21.2 N) of 5.5 g/10 minutes. ·High-flow PP1: high-flow PP (trade name: BC06C) manufactured by Japan Polypropylene Corporation, and having an MFR (230° C., 21.2 N) of 60 g/10 minutes. ·High-flow PP2: high-flow PP (trade name: BC05B) manufactured by Japan Polypropylene Corporation, and having an MFR (230° C., 21.2 N) of 50 g/10 minutes.

·Peroxide: organic peroxide (trade name: PERHEXA 25B) manufactured by NOF Corporation, and having a one-minute half-life temperature of 180° C. ·Talc: master batch (trade name: MAT-725TP) obtained by dispersing talc in PP manufactured by Shiraishi Calcium Kaisha, Ltd., and having a PP content of 70% by mass. ·Powder talc: fine powder talc (trade name: P-3) manufactured by Nippon Talc Co., Ltd., and having a particle diameter of 5 μm. ·Rubber: ethylene/1-octene copolymer (trade name: ENGAGE8842) (uncrosslinked) manufactured by Dow Chemical Company, and having a specific gravity of 0.857.

Blending numerical values of the respective materials in Table 1 are % by mass with respect to 100% by mass of the total raw materials.

Details of the items regarding the mass ratio in Table 1 are as follows. ·Used PP/total polymer: mass ratio of used PP to total polymer in olefin-based composition ·Rubber/total polymer: mass ratio of ethylene-α-olefin copolymer rubber to total polymer in olefin-based composition·PE/total polymer: mass ratio of PE to total polymer in olefin-based composition·(Rubber+PE)/total polymer: mass ratio of total of ethylene-α-olefin copolymer rubber and PE to total polymer in olefin-based composition·High-flow PP/total resin: mass ratio of high-flow PP to total resin in olefin-based composition·Peroxide/(rubber+PE): mass ratio of peroxide to total of ethylene-α-olefin copolymer rubber and PE

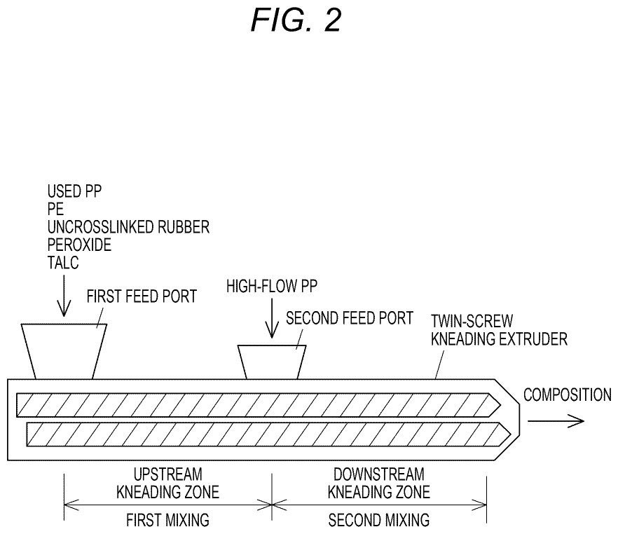

As illustrated in FIG. 2, mixing of the raw materials was carried out by
(1) carrying out a first mixing of feeding the used PP, the uncrosslinked rubber, the PE, the peroxide, and the talc from a first feed port in an upstream part of one kneading extruder, mixing and kneading the materials in an upstream kneading zone from the upstream part to a midstream part of the kneading extruder, and crosslinking the uncrosslinked rubber and the PE, and
(2) subsequently carrying out a second mixing of feeding the high-flow PP from a second feed port at the midstream part of the kneading extruder, mixing and kneading the mixture obtained in the first mixing and the high-flow PP in a downstream kneading zone from the midstream part to a downstream part of the kneading extruder.

A difference between the twin-screw kneading extruder used in Examples 1, 2, and 5 to 8 and the single-screw kneading extruder used in Examples 3, 4, and 9 was mainly a difference in conveyance speed, and was not much related to the properties of the composition.

The olefin-based compositions of Examples 1 to 9 and Comparative Examples 1 and 2 extruded from the kneading extruder were injection-molded into a mold (mold temperature: 40° C.) by an injection molding machine (cylinder temperature: 200° C.) to prepare molded bodies corresponding to measurement, which were subjected to the following measurement.

### 1. Odor Test (Sensory Test)

A flat plate-shaped molded body having a side length of 60 mm and a thickness of 2.0 mm was prepared by the injection molding. Two molded bodies were placed in an odorless resin bag having a capacity of 0.5 L, with a lid thereof being closed and sealed, followed by heating in an oven at 65° C. for 2 hours. After heating, the resin bag was allowed to stand at a room temperature for 5 minutes. Next, six panelists evaluated the odor of the sample in the bag. Specifically, each of the six panelists scored the odor in increments of 0.5 points based on the following scale. Among the scores scored by the panelists, the total score obtained by excluding the upper and lower limits was divided by 4 to calculate an average score, and evaluation was performed based on the average score. A target value was set to 3 points or less (more preferably 2 points or less) in odor intensity and 1 point or less (more preferably 0.5 points or less) in odor discomfort degree.

### (Scoring Criteria)

The odor intensity was scored as “1 point: no odor is sensed, 2 points: odor is slightly sensed, 3 points: odor is sensed weakly, 4 points: odor is sensed, 5 points: odor is sensed strongly”.

The degree of odor unpleasantness was scored as “−2 points: not unpleasant, −1 point: odor slightly felt but not unpleasant, 0 points: no odor felt, 1 point: slightly unpleasant, 2 points: unpleasant”.

### 2. MFR (Fluidity)

The MFR of the olefin-based composition was measured at a temperature of 230° C. and a load of 21.2 N in accordance with ISO1133. A target value was set to 15 g/10 minutes or more (more preferably 20 g/10 minutes or more).

### 3. Charpy Impact Value (Impact Resistance)

In accordance with ISO 179, a notched test piece (length: 80 mm×width: 10 mm×thickness: 4 mm, notch depth: 2 mm, notch radius: 0.25 mm) was prepared by injection molding and cutting out, and was subjected to a Charpy impact test with a 2 J hammer at 23° C. to measure a Charpy impact value. A target value was set to 7 kJ/m² or more (more preferably 12 kJ/m² or more).

### 4. Tensile Elastic Modulus (Stiffness)

In accordance with ISO 527, an ISO No. 1 dumbbell test piece was prepared by injection molding and cutting out, and the tensile elastic modulus was measured at 23° C. at a tensile speed of 1 mm/min. A target value was set to 1.8 GPa or more (more preferably 2 GPa or more).

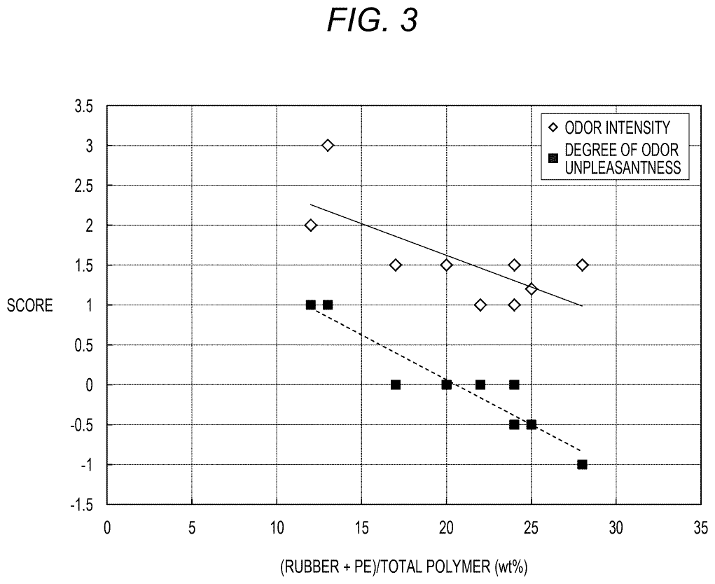

The measurement results are shown in Table 1 below. In FIG. 3, results of the odor test of Examples 1 to 9 are plotted in association with (rubber+PE)/total polymer. Hereinafter, consideration will be given.

### (Regarding Reduction of Odor)

In Comparative Examples 1 and 2, the odor intensity is 4 to 5 points and the degree of odor unpleasantness is 2 points.

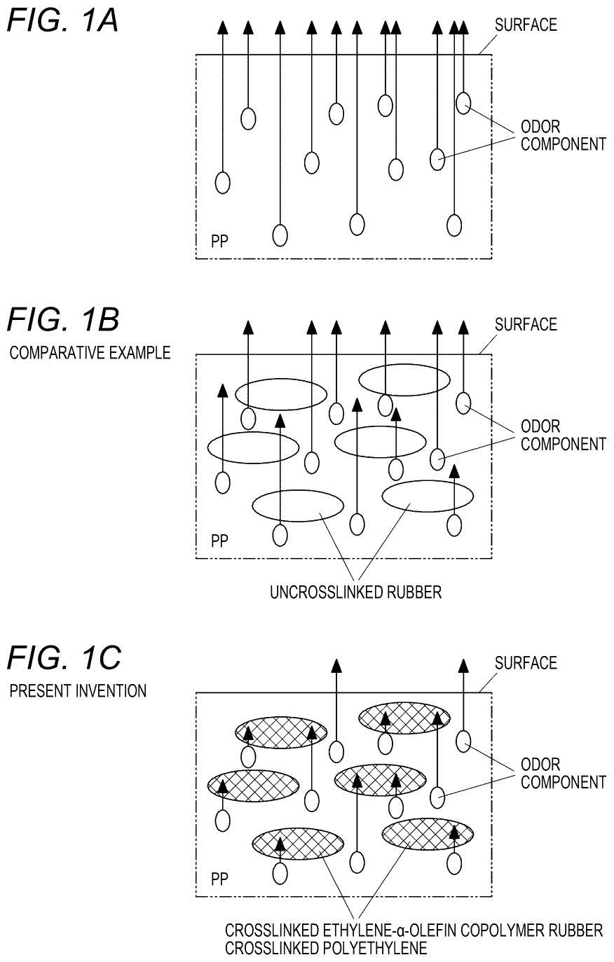

On the other hand, in Examples 1 to 9, the odor intensity is 3 points or less, the degree of odor unpleasantness is 1 point or less, and reduction of odor is confirmed. As described above with reference to FIG. 1C, the crosslinked rubber and the crosslinked PE are considered to have an effect of retaining the odor component.

Examples 1 to 8 are more preferable examples in that the odor intensity is 2 points or less and the degree of odor unpleasantness is 0.5 points or less.

The reason why the odor intensity is 3 points and the degree of odor unpleasantness is 1 point in Example 9 is considered to be that the mass ratio of the peroxide to the total of the ethylene-α-olefin copolymer rubber and PE is higher than that in Examples 1 to 8, and the odor due to the decomposition residue of the peroxide is slightly added. Therefore, it is estimated that the odor intensity is 2 points or less and the degree of odor unpleasantness is 0.5 points or less by setting the mass ratio to about 8% by mass based on comparison with Examples 1 to 8.

### (Regarding PE)

In Examples 1, 2, and 4 to 8, the reason why the odor intensity and the degree of odor unpleasantness are further improved as compared with Examples 3 and 9 is that the mixing of PE may be one cause.

### (Regarding MFR)

Examples 1 to 9 are more preferable examples in that the MFR is 20 g/10 minutes or more.

However, depending on the molding method, molding may be easy even with an MFR of 15 g/10 min, and therefore the MFR can be adjusted to 15 g/10 min or more, for example, by reducing or not containing high-flow PP in Examples 1 to 9.

The present disclosure is not limited to the aforementioned Examples and can be appropriately modified and carried out as follows within a scope that does not deviate from the spirit of the invention.
(1) In the second mixing, a peroxide is additionally mixed to decompose the high-flow polypropylene.
(2) The first mixing is performed by a first kneading extruder, and the second mixing is performed by a second kneading extruder different from the first kneading extruder.

What is claimed is:

1. An olefin-based composition comprising: used polypropylene and crosslinked ethylene-α-olefin copolymer rubber in a mass smaller than a mass of the used polypropylene.

2. The olefin-based composition according to claim 1, wherein a mass ratio of the used polypropylene to a total polymer in the olefin-based composition is 20 to 60% by mass, and a mass ratio of the ethylene-α-olefin copolymer rubber to the total polymer in the olefin-based composition is 5 to 25% by mass.

3. The olefin-based composition according to claim 2, wherein crosslinked polyethylene is not contained or is further contained, and a total mass ratio of the ethylene-α-olefin copolymer rubber and the polyethylene to the total polymer in the olefin-based composition is 10 to 30% by mass.

4. The olefin-based composition according to claim 1, further comprising: high-flow polypropylene having higher fluidity than the used polypropylene, wherein a mass ratio of the high-flow polypropylene to a total resin in the olefin-based composition is 15 to 60% by mass.

5. The olefin-based composition according to claim 1, having an MFR at 230° C., 21.2 N of 15 g/10 min or more.

6. The olefin-based composition according to claim 1, having a Charpy impact strength at 23° C. of 7 kJ/m² or more.

7. The olefin-based composition according to claim 1, having a tensile elastic modulus at 23° C. of 1.8 GPa or more.

8. The olefin-based composition according to claim 1, wherein an odor intensity by a sensory test is 3 points or less on a scale of 1 to 5 points.

9. A resin molded product molded from the olefin-based composition according to claim 1.

10. A method for producing an olefin-based composition, comprising:
a first mixing a raw material containing used polypropylene, uncrosslinked ethylene-α-olefin copolymer rubber in a mass smaller than a mass of the used polypropylene, and a peroxide to crosslink the ethylene-α-olefin copolymer rubber with the peroxide.

11. The method for producing an olefin-based composition according to claim 10, wherein in the first mixing, the raw material contains no polyethylene or further contains polyethylene, and when the raw material contains polyethylene, the polyethylene is crosslinked with the peroxide.

12. The method for producing an olefin-based composition according to claim 11, wherein a mass ratio of the peroxide to a total of the ethylene-α-olefin copolymer rubber and the polyethylene is 1 to 11% by mass.

13. The method for producing an olefin-based composition according to claim 10, wherein in the first mixing, the raw material further contains high-flow polypropylene having higher fluidity than the used polypropylene.

14. The method for producing an olefin-based composition according to claim 10, further comprising:
a second mixing a mixture obtained in the first mixing with high-flow polypropylene having higher fluidity than the used polypropylene.

15. The method for producing an olefin-based composition according to claim 10,
wherein the mixing is performed by a kneading extruder.

16. The method for producing an olefin-based composition according to claim 14,
wherein the mixing is performed by a kneading extruder.
